(19) United States
(12) Patent Application Publication
(10) Pub. No.: US 2019/0348843 A1
(43) Pub. Date: Nov. 14, 2019

(54) ACTIVE CELL BALANCING USING FLYING CAPACITOR OR CELL

(71) Applicant: Renesas Electronics America Inc., Milpitas, CA (US)

(72) Inventor: Tetsuo Sato, San Jose, CA (US)

(21) Appl. No.: 16/409,506

(22) Filed: May 10, 2019

Related U.S. Application Data
(60) Provisional application No. 62/671,337, filed on May 14, 2018.

(51) Int. Cl. H02J 7/00; H01M 10/0525; H01M 10/44

(52) U.S. Cl. CPC H02J 7/0016; H01M 10/441; H01M 10/0525; H02J 7/0021

(57) ABSTRACT

The present embodiments relate generally to energy storage and more particularly to methods and apparatuses for performing active cell balancing in rechargeable battery devices. Some embodiments use a flying capacitor architecture for transferring charge between battery cells, and a BEOL process MOSFET for switching the flying capacitor between over-charged and under-charged cells. In other embodiments adapted for use with large power battery systems, a super capacitor or battery cell is used as the charge transfer component instead of a capacitor, and B2B connected MOSFETs are used for the switching components.

### CROSS-REFERENCE TO RELATED APPLICATIONS

The present application claims priority to U.S. Provisional Patent Application No. 62/671,337 filed May 14, 2018, the contents of which are incorporated herein by reference in their entirety.

### TECHNICAL FIELD

The present embodiments relate generally to energy storage and more particularly to cell balancing in rechargeable battery devices.

### BACKGROUND

A rechargeable battery or storage battery is typically a group of one or more electrochemical cells (i.e. battery pack). Rechargeable batteries come in many different shapes and sizes. Rechargeable batteries are used for portable consumer devices (e.g., smart phones, tablets, laptop computers, notebook computers, etc.), vehicles (such as motorized wheelchairs, golf carts, etc.), tools, uninterruptible power supplies, etc.

Several different combinations of chemicals are commonly used in rechargeable batteries, including: lead-acid, nickel cadmium (NiCd), nickel metal hydride (NIMH), lithium ion (Li-ion), and lithium ion polymer (Li-ion polymer). Of these different chemical combinations, lithium-based (i.e. Li+) battery technology offers performance advantages over traditional battery technologies at the cost of increased monitoring and controls overhead. More particularly, while Lead-Acid battery packs can be equalized by a controlled overcharge, eliminating the need to periodically adjust individual cells to match the rest of the pack, Lithium-based batteries cannot be equalized by an overcharge, so alternative methods are required. For example, careful monitoring and controls must be implemented to avoid any single cell from experiencing an overvoltage due to excessive charging. This is because, for series connected lithium cells, even though the end-to-end pack voltage may appear to be within acceptable limits, one cell of the series string may be experiencing damaging voltage due to cell-to-cell imbalances.

A solution to these and other problems is therefore needed.

### SUMMARY

The present embodiments relate generally to energy storage and more particularly to methods and apparatuses for performing active cell balancing in rechargeable battery devices. Some embodiments use a flying capacitor architecture for transferring charge between battery cells, and a BEOL process MOSFET for switching the flying capacitor between over-charged and under-charged cells. In other embodiments adapted for use with large power battery systems, a super capacitor or battery cell is used as the charge transfer component instead of a capacitor, and B2B connected MOSFETs are used for the switching components.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a circuit diagram of an example conventional passive cell balancing approach;

FIG. 2 is a circuit diagram of an example active cell balancing approach according to the embodiments, including a flying capacitor architecture;

FIG. 3 is a cross-sectional diagram of an example BEOL transistor that can be used in the embodiment of FIG. 2;

FIG. 4 is a flowchart illustrating an example active cell balancing methodology according to the present embodiments; and

FIG. 5 is a circuit diagram illustrating another example active cell balancing approach according to the embodiments, using B2B MOSFETs and suitable for an EV system.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

According to certain general aspects, the present embodiments relate to methods and apparatuses for performing active cell balancing in rechargeable battery devices. Some embodiments use a flying capacitor or similar architecture for transferring charge between battery cells, and switches for switching the flying capacitor between over-charged and under-charged cells. In these and other embodiments, an active balancing methodology includes intelligently and continuously selecting pairs of cells for balancing.

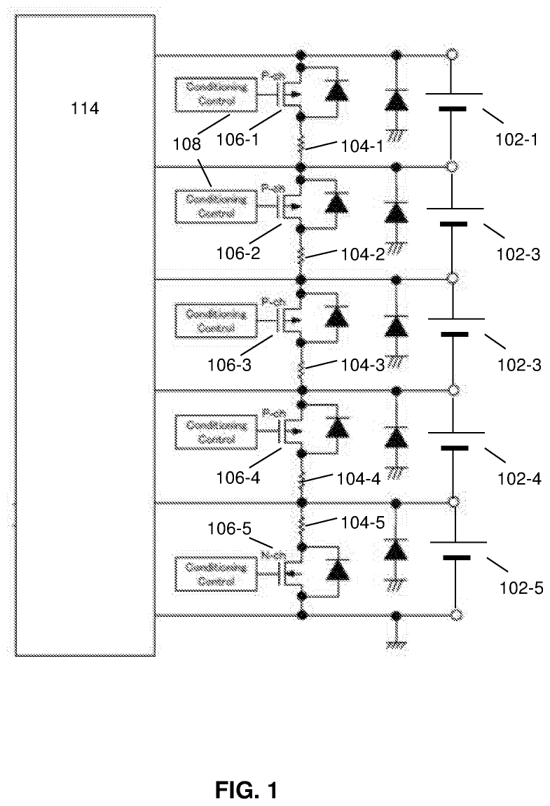

FIG. 1 is a schematic diagram illustrating a conventional passive approach to cell balancing. Although five series-connected cells 102 are shown in this example, the number of cells can be more or fewer.

As further shown in this example, coupled to each cell 102-1 to 102-5 is a respective resistor 104-1 to 104-5 and switch 106-1 to 106-5 (implemented as a MOSFET in this example). A conditioning control circuit 108 is coupled to each switch so as to control the cell balancing operation, perhaps among other things. Specifically, conditioning control circuit 108 implements a dissipative approach which shunts selected cells 102 with resistors 104 (e.g. also using mux 114) to remove charge from the highest cells until they match the charge of the lowest cells. If the resistor value is chosen so that the shunt current I_{S} is small (<10 mA/hr capacity), the physical resistor size and switch rating can be small. A 10 mA/hr resistor could balance severely high cells at a rate of 1% per hour. However, if operated continuously, such a technique could drain the entire battery pack in a few days.

In order to overcome various issues in connection with conventional “passive” approaches such as that shown in FIG. 1, some “active” approaches have been considered. One such approach is referred to as flying capacitor active cell balancing. This method involves using a number of switches rated at the peak charging current for a “flying” capacitor C. For an ideal system (no ESR in the capacitor or switching losses), with a very large cell imbalance (e.g. Bn=3.0V, Bm=4.0V), a flying capacitor could balance these cells at an initial rate of 1 A per hour per 1000 uF of capacitance switching at 1 kHz with an average switch current of 1 A. Figuring in the capacitor ESR and switching losses dramatically increases the system's time constant for charging and discharging, effectively reducing actual balancing current by at least an order of magnitude and increasing the peak switch current. The larger the capacitor used, the longer it will take to transfer a usable charge and the clock rate will have to be decreased and the peak switch current will increase. However, in an actual Li+ multi-cell battery pack case, cell imbalance will remain a few hundred millivolts, so given the same conditions (1000 uF switching at 1 kHz), the current remains a few hundred milliamperes. Under this condition, a flying capacitor approach is a reasonable cell balancing solution.

The present applicant has recognized that the main reason why flying capacitor approaches have not been widely implemented is the tradeoff between cost and performance improvement. The flying capacitor active cell balancing approach requires many switches for switching the flying capacitor between battery cells. For example, in some approaches, the switching circuit consists of many back-to-back (B2B) connected MOSFETs. More particularly, it requires two B2B MOSFETs per cell, which means a total of four MOSFETs per cell are required. This renders this approach cost prohibitive in many applications.

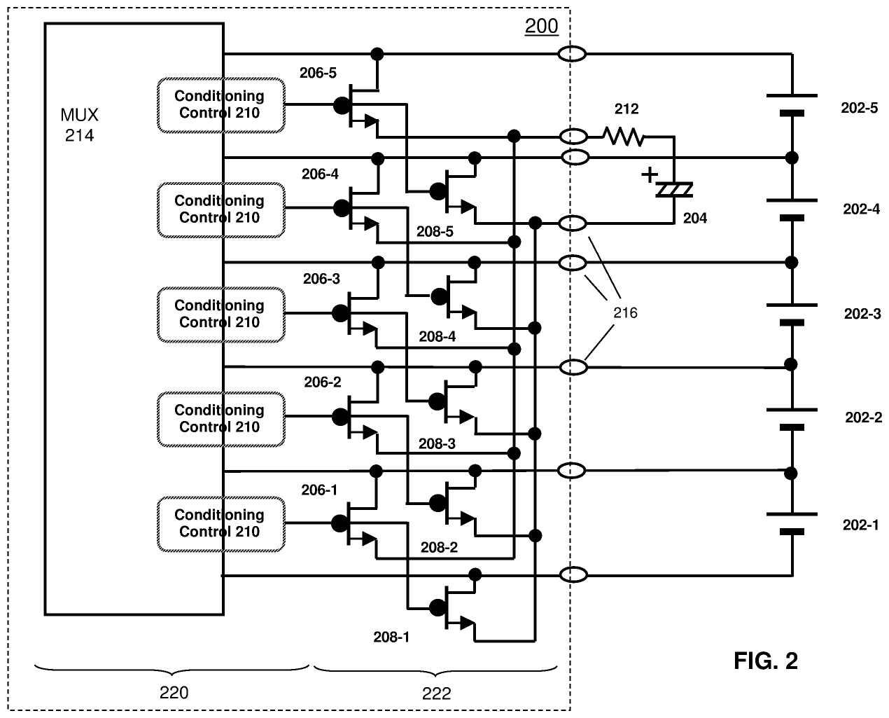

According to certain general aspects, the present embodiments aim to improve the tradeoff between cost and performance while implementing the flying capacitor architecture for active cell balancing. In one embodiment, this is achieved by implementing low-cost switching devices in the switching circuit. FIG. 2 is a schematic diagram illustrating one example of this approach according to the present embodiments.

As shown, this example balancing circuit 200 uses a “flying capacitor” 204 and is configured for balancing charge among five series-connected Li+ battery cells 202-1 to 202-5 rated at 1 A and 1 H. However, this example is non-limiting, and other embodiments can include fewer or more cells, as well as other types of batteries. To perform cell balancing, balancing circuit 200 includes switches 206-1 to 206-5, 208-1 to 208-5 coupled to cells 202-1 to 202-5 and flying capacitor 204. These are controlled by conditioning circuit 210 that is connected to the gate of each switch 206, 208.

More particularly, according to certain aspects to be described in more detail below, conditioning circuit 210 continuously and intelligently selects which cells to balance. In this way, the capacitor 204 can be charged from the highest charged one of cells 202 (using a selected one of switches 206) and selectively discharged to the lowest charged one of cells 202 (using a selected one of switches 208). This method can dramatically reduce the time to charge balance the cells, especially if the highest and lowest charged cells are on the opposite ends of the pack. Additional controls (not shown) are used to detect and select the target cells for balancing.

In embodiments, balancing circuit 200 is implemented by or in an integrated circuit. Cells 202, capacitor 204 and resistor 212 are connected to circuit 200 via pins 216 and wires, PCB traces, etc. As further shown in this example, circuit 200 includes a front end of line (FEOL) portion 220 and a back end of line (BEOL) portion 222. It should be appreciated that balancing circuit 200 can be included in a battery management device or circuit that can include various other components (not shown) such as ADCs, clocks, etc. Of these, Mux 214 is shown for clarifying connections to such circuitry to individual or selected ones of cells 202 to such other components, as well as to conditioning circuit 210. In these and other embodiments, circuit 200 can be implemented by, or included in a MCU or AFE chip, which can perform other battery management functions such as charging. However, components for performing such other functions are not shown for clarity of the present embodiments.

According to certain cost-efficient aspects of the present embodiments such as the example of FIG. 2, switches 206 and 208 are implemented by BEOL MOSFETs. In addition to the cost savings and space savings achieved by using a BEOL process, and as will be described in more detail below, such MOSFETs have no body diode, and so the same switches 206 and 208 can be used for both charging and discharging operations, thereby reducing the number of devices needed in conventional approaches by a factor of two.

To illustrate non-limiting example cost-efficient aspects of the present embodiments, switches 206 and 208 implemented by BEOL MOSFETs can be produced at a cost of about $0.25 each, which means that all ten of switches 206 and 208 can be produced at a cost on the order of about $2.50 for a five cell case. Meanwhile, to illustrate the feasibility of using the BEOL process to implement switches 206 and 208, a non-limiting example in which the switches are NFETs implemented by an InGaZnO thin film transistor (TFT) with an Rdson of 1.2 ohm, the size of each switch is about 0.09 mm², whereas a typical IC including an MCU and/or AFE is about 2 mm×2.5 mm.

As set forth above, circuit 200 includes an FEOL portion 220 and a BEOL portion 222. In this regard, and as known in the art, integrated circuits such as circuit 200 are fabricated using a FEOL process and a BEOL process. FEOL is the first portion of IC fabrication where individual devices (transistors, capacitors, resistors, etc.) are patterned in a semiconductor wafer. FEOL may also include the formation of polysilicon that locally interconnects devices that are very close to each other. FEOL generally covers everything up to (but not including) the deposition of metal interconnect layers. BEOL is the second portion of IC fabrication where devices are globally interconnected with metal wiring. BEOL generally begins when the first layer of metal is deposited on the wafer. BEOL includes the formation of contacts or vias, insulating layers (dielectrics), metal wiring, and bonding sites. Ten or more metal interconnect layers can be added during the BEOL portion of IC fabrication. The top-most layers have the thickest, widest and most widely-separated metal wires, which make them very well suited for power or clock distribution since they have the least resistance and smallest RC time delay.

According to aspects of the embodiments, circuit 200 is fabricated using both a FEOL process and a BEOL process. Most of the components, including conditioning circuit 210 and mux 214, are formed during the FEOL portion 220 of circuit 200 fabrication. By contrast, some or all of switches 206 and 208 are partially or fully formed during the BEOL portion 222 of circuit 200 fabrication.

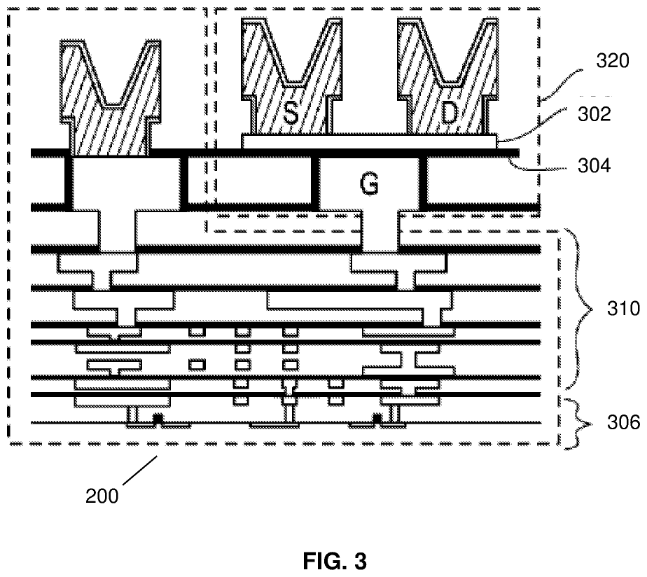

FIG. 3 is a cross-sectional diagram of an example circuit 200 including an example BEOL transistor that can be used to implement switches 206 and 208 shown in FIG. 2. As shown in the example of FIG. 3, switches 206, 208 include a thin film transistor (TFT) 320. In some embodiments, TFT 320 is fabricated with an active semiconductor layer of wide band-gap InGaZnO, it being understood that alternative semiconductor layers are contemplated. TFT 320 lacks a body diode. U.S. Pat. No. 9,082,643, and Kaneko, K. et. al., “A Novel BEOL-Transistor (BETr) with InGaZnO Embedded in Cu-Interconnects for On-chip High Voltage I/Os in Standard CMOS LSIs”, 2011 Symposium on VLSI Technology Digest of Technical Papers, pp. 120-121 (2011), both of which are incorporated herein by reference, describe at least one example method for forming devices such as TFT 320 during the BEOL process.

As further shown in FIG. 3, TFT 320 includes a thin layer 302 of InGaZnO or other semiconductor material, an insulating layer 304 that separates the InGaZnO layer from a copper gate G, an aluminum source S and an aluminum drain D. TFT 320 is fabricated using the top two BEOL pattern layers. The FEOL formed components 306 (e.g., conditioning circuit 210, mux 214, timers, comparators, etc.) of the circuit 200 core are separated from TFT 320 by several layers 310 of metal interconnect, which are also created using the BEOL process.

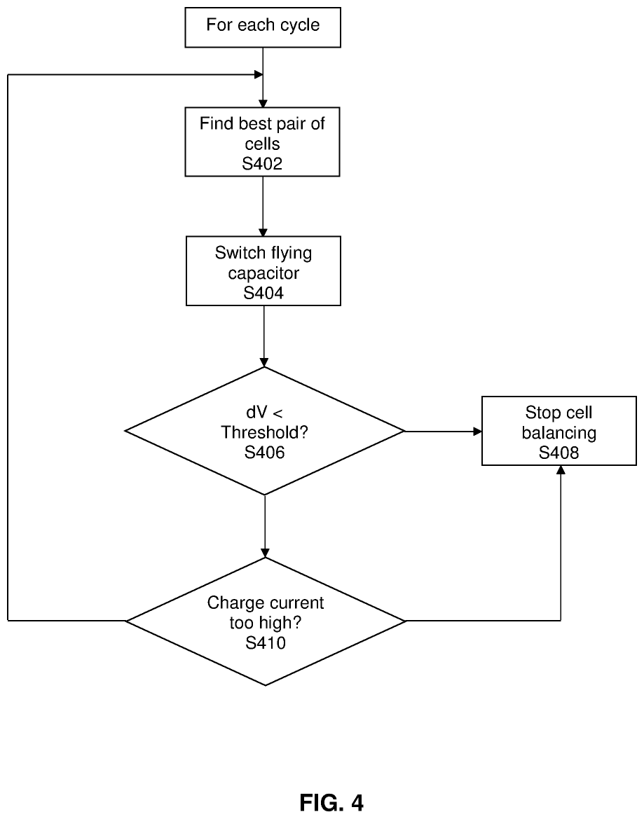

FIG. 4 is a flowchart illustrating an example active cell balancing methodology according to embodiments.

As shown in this example, when active cell balancing is being performed, by conditioning circuit 210 for example, a cycle by cycle process is performed. This is because the highest and lowest charged cells may change during the cell balancing process. In one example, where the value R of resistor 212 is about 8.2 ohms, the value of the flying capacitor 204 is about 4700 uF, and the cells are rated at 1 A and 1 H, the switching frequency can be 100 Hz. Under these conditions, the cell balancing time for reducing the difference dV between the highest and lowest charged cells from dV to dV/2 is about 35 hours (1.5 days). This example is useful for relatively low power Li+ portable battery applications and for achieving good cell balance for longer battery life and safe operation at low cost and small space requirements.

For each cycle at this switching frequency, the cell voltages are monitored in step S402 to find the best pair of cells having the highest difference (dV) in charge. After identifying these cells, the appropriate switches are controlled in step S404 so as to cause the flying capacitor to transfer charge between the identified pair of cells.

As further shown in this example, in step S406, when the highest cell delta voltage dV between any pair of cells is within an acceptable value (even not equal), active cell balancing is stopped in S408 to reduce power consumption. Moreover, even when this dV threshold is exceeded, in step S410, the discharge current is monitored and the cell balancing operation is stopped under a high discharge current condition to prevent missing cell voltage leveling. Those skilled in the art will understand that the precise values of the threshold dV and threshold high discharge current will depend on various factors, including the types and capacities of the battery cells, the flying capacitor and the switches, as well as desired operating performance.

It should be noted that after cell balancing is stopped in S408, continuous monitoring of cell imbalances can still be performed, and the cell balancing process in FIG. 4 can be restarted when any cell pair imbalance exceeds the dV threshold.

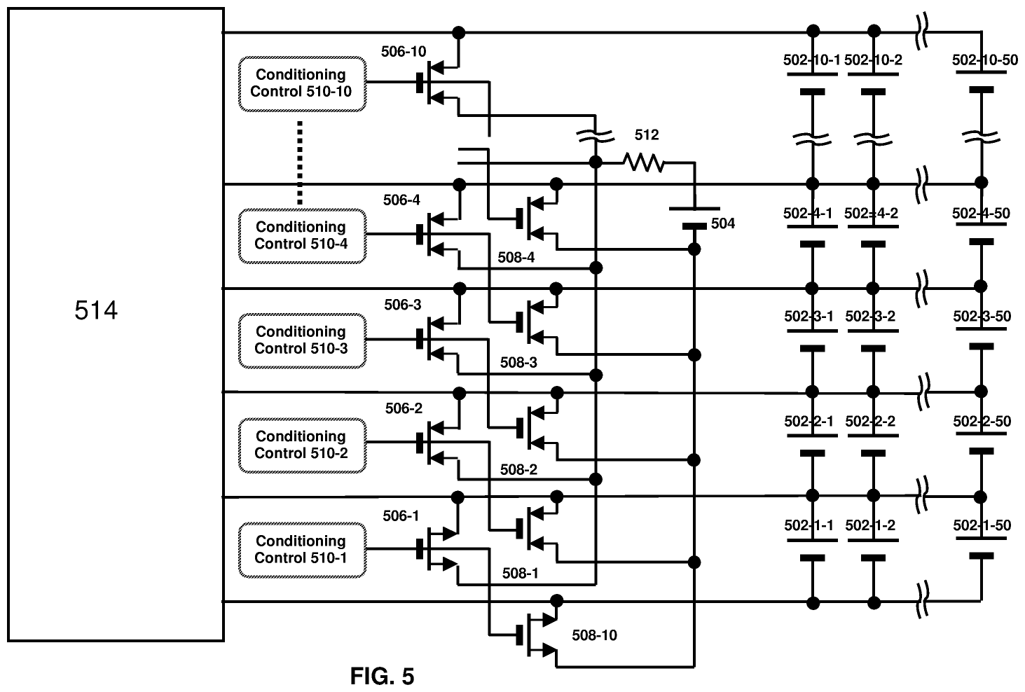

FIG. 5 shows another example of an active cell balancing system according to embodiments, which is particularly useful for very high power battery system such as electric vehicles or uninterrupted power supplies.

As shown, this example balancing circuit uses a flying cell 504, which can be a Li+ cell configured as the charge transfer component. Moreover, this circuit is configured for balancing charge among ten series-connected Li+ battery cells 502 in fifty parallel strings (e.g., a 10S-50P cell pack providing 36 V, 200 Ah and 7.2 kWh for an EV). However, this example is non-limiting, and other embodiments can include fewer or more cells, as well as other types of batteries. To perform cell balancing, the balancing circuit includes switches 506-1 to 506-10, 508-1 to 508-10 coupled to cells 502-1-1 to 502-10-50 and flying cell 504. These switches are controlled by conditioning circuit 510 that is connected to the gate of each switch 506, 508.

In this example embodiment, switches 506, 508 can be implemented by back-to-back MOSFETs. More particularly, with the above described example number and types of cells 502, switches 506-2 to 506-10 and 508-1 to 508-9 can be implemented by P-channel MOSFETs, while switches 506-1 and 508-10 can be implemented by N-channel MOSFETs.

Conditioning control circuit 510 and mux 514 can implement an active cell balancing methodology that is similar to that described above, except where cells 502 in parallel strings are considered together for identifying appropriate pairs for coupling to the flying cell 504. Those skilled in the art will understand how to adapt the methodology of FIG. 4 for use in the embodiment of FIG. 5 after being taught by the present disclosure. Consider one example wherein the cell pair imbalance voltage is 100 mV (e.g., the charge on cells 502-4-1 to 502-4-50 is about 4.0 V and the charge on cells 502-2-1 to 502-2-50 is about 3.9 V, with all the cells having the same materials, size and capacity), the total loop resistance including flying capacitor/cell 504 is about 4 mOhm (e.g., the sum of Rdson of MOSFET 506-3 plus resistance of 512 plus Rdson of MOSFET 508-3) and the switching frequency is 100 Hz at a 50% duty cycle. In this example, the cell balancing operation will complete in about 2000 minutes (about 1.4 days), and all cell voltages will converge to about 3.95V.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A circuit, comprising:
a front end of line portion and a back end of line portion;
a plurality of first switches coupled to a plurality of cells and configured to control a charging operation of a flying capacitor from a selective one of the plurality of cells; and
a plurality of second switches coupled to the plurality of cells and configured to control a discharging operation of the flying capacitor to a selective other one of the plurality of cells,
wherein certain of the first and second switches are implemented in the back end of line portion.

2. The circuit of claim 1, wherein the certain first and second switches are thin film transistors.

3. The circuit of claim 2, wherein the thin film transistors comprise an active semiconductor layer of wide band-gap material.

4. The circuit of claim 1, further comprising a conditioning circuit coupled to the plurality of first switches and to the plurality of second switches.

5. The circuit of claim 4, wherein the conditioning circuit is connected to gates of transistors implementing the plurality of first switches and the plurality of second switches.

6. The circuit of claim 4, wherein the conditioning circuit is configured to select the selective one and the selective other one of the plurality of cells based on a difference in charge between the selective one and the selective other one of the plurality of cells.

7. The circuit of claim 1, wherein the plurality of cells comprises a string of series connected cells.

8. The circuit of claim 7, wherein the string of series connected cells comprise Li+ battery cells.

9. A method of balancing charge among a plurality of cells using a flying capacitor, comprising:
controlling a switching cycle of the flying capacitor;
during each switching cycle, identifying a highest charged one of the plurality of cells and a lowest charged one of the plurality of cells;
controlling a charging operation of the flying capacitor from the identified highest charged one of the plurality of cells; and
controlling a discharging operation of the flying capacitor to the identified lowest charged on of the plurality of cells.

10. The method of claim 9, further comprising:
comparing a difference in charge between the identified highest charged one of the plurality of cells and the identified lowest charged one of the plurality of cells to a threshold; and
stopping the charging operation of the flying capacitor and the discharging operation of the flying capacitor if the difference is lower than the threshold.

11. The method of claim 9, further comprising:
monitoring a discharge current of the discharging operation of the flying capacitor; and
stopping the charging operation of the flying capacitor and the discharging operation of the flying capacitor if the monitored discharge current indicates a high discharge current condition.

12. A circuit, comprising:
a plurality of first switches coupled to a plurality of cells and configured to control a charging operation of a charge transfer component from selective ones of the plurality of cells; and
a plurality of second switches coupled to the plurality of cells and configured to control a discharging operation of the charge transfer component to selective other ones of the plurality of cells,
wherein the plurality of cells comprise a plurality of parallel strings of series-connected cells.

13. The circuit of claim 12, wherein the first and second switches each comprise back-to-back (B2B) MOSFETS.

14. The circuit of claim 13, wherein a conductivity type of the B2B MOSFETs implementing the first switches and the conductivity type of the B2B MOSFETs implementing the second switches are different.

15. The circuit of claim 12, further comprising a conditioning circuit coupled to the plurality of first switches and to the plurality of second switches.

16. The circuit of claim 15, wherein the conditioning circuit is connected to gates of transistors implementing the plurality of first switches and the plurality of second switches.

17. The circuit of claim 15, wherein the conditioning circuit is configured to select the selective ones and the selective other ones of the plurality of cells based on a difference in charge between the selective ones and the selective other ones of the plurality of cells.

18. The circuit of claim 12, wherein the plurality of cells comprise Li+ battery cells.

19. The circuit of claim 12, wherein the charge transfer component comprises a super capacitor.

20. The circuit of claim 12, wherein the charge transfer component comprises a battery cell.
